(19) United States
(12) Patent Application Publication
(10) Pub. No.: US 2015/0022786 A1
(43) Pub. Date: Jan. 22, 2015

(54) Projector System and Projector

(71) Applicant: Funai Electric Co., Ltd., Osaka (JP)

(72) Inventors: Kazuhiro TAKAHASHI, Daito-shi (JP); Atsuya HIRANO, Daito-shi (JP)

(21) Appl. No.: 14/319,791

(22) Filed: Jun. 30, 2014

(30) Foreign Application Priority Data
Jul. 22, 2013 (JP) 2013-151517

(51) Int. Cl. G03B 21/14; G02B 7/182; G03B 21/28

(52) U.S. Cl. CPC G03B 21/147; G03B 21/142; G03B 21/28; G02B 7/182
USPC 353/69

(57) ABSTRACT

A projector system includes a projector including a light projection portion projecting an image and a control portion and a light reflector including a mirror portion reflecting light constituting the image projected by the projector to a prescribed region, a drive portion moving the mirror portion, and a position detecting portion capable of detecting the position of the mirror portion. The control portion of the projector is configured to acquire positional information of the mirror portion from the light reflector and switch the image projected by the projector on the basis of the positional information of the mirror portion.

### BACKGROUND OF THE INVENTION

1. Field of the Invention

The present invention relates to a projector system and a projector, and more particularly, it relates to a projector system and a projector each projecting an image on a light reflector.

2. Description of the Background Art

A system projecting an image on a light reflector is known in general. Such a projector system and a projector are disclosed in Japanese Patent Laying-Open No. 2000-057819.

The aforementioned Japanese Patent Laying-Open No. 2000-057819 discloses a system including an emitting portion projecting an image (character string ABC) and a mirror ball (light reflector). This mirror ball includes a plurality of reflective plate pieces (mirror portions) reflecting light constituting the image projected by the emitting portion to a prescribed region and a rotating portion rotating the reflective plate pieces. The plurality of reflective plate pieces are arranged on a surface of the mirror ball. This system is configured to project the image on a wall surface or the like by reflecting the light by the reflective plate pieces.

In the system described in the aforementioned Japanese Patent Laying-Open No. 2000-057819, however, may fail to reliably project the image by the reflective plate pieces by projecting the image on a position between adjacent reflective plate pieces when the reflective plate pieces are rotated. In this case, the image reflected by the moving (rotating) reflective plate pieces is disadvantageously separated (includes breaks) on a projection surface such as the wall surface. Thus, the quality of the image projected by the plurality of moving reflective plate pieces (mirror portions) is reduced.

### SUMMARY OF THE INVENTION

The present invention has been proposed in order to solve the aforementioned problem, and an object of the present invention is to provide a projector and a projector system including the same each capable of suppressing a reduction in the quality of an image projected by a moving mirror portion.

A projector system according to a first aspect of the present invention includes a projector including a light projection portion projecting an image and a control portion and a light reflector including a mirror portion reflecting light constituting the image projected by the projector to a prescribed region, a drive portion moving the mirror portion, and a position detecting portion capable of detecting the position of the mirror portion, and the control portion of the projector is configured to acquire positional information of the mirror portion from the light reflector and switch the image projected by the projector on the basis of the positional information of the mirror portion.

As hereinabove described, the projector system according to the first aspect of the present invention is provided with the control portion of the projector acquiring the positional information of the moving mirror portion from the light reflector and switching the image projected by the projector on the basis of the positional information of the moving mirror portion, whereby the image can be reliably projected on the mirror portion on the basis of the positional information of the moving mirror portion even if the position of the mirror portion is changed, and hence separation (breaks) of the image reflected by the mirror portion on a projection surface such as a wall surface can be suppressed. Consequently, a reduction in the quality of the image projected by the moving mirror portion can be suppressed.

In the aforementioned projector system according to the first aspect, the control portion of the projector is preferably configured to switch the image projected by the projector in synchronization with movement of the mirror portion on the basis of the positional information of the mirror portion. According to this structure, the image can be projected to accommodate the movement of the mirror portion on the basis of the positional information of the mirror portion even if the position of the mirror portion is changed, and hence the separation (breaks) of the image reflected by the moving mirror portion on the projection surface such as the wall surface can be effectively suppressed.

In this case, the control portion of the projector is preferably configured to calculate the movement speed of the mirror portion from the positional information of the mirror portion and switch the image projected by the projector in synchronization with the movement of the mirror portion on the basis of the movement speeds that is calculated. According to this structure, the image can be easily projected to accommodate the movement of the mirror portion, employing information about the speed of the mirror portion.

In the aforementioned projector system according to the first aspect, the light projection portion preferably includes a light scanning portion projecting the image by scanning the light, and the control portion of the projector is preferably configured to acquire the positional information of the mirror portion from the light reflector and switch the image scanned by the light scanning portion such that the light is emitted only to the mirror portion on the basis of the positional information of the mirror portion. According to this structure, even if a member having high reflectance is provided outside (around) the mirror portion, for example, unintended reflection of the light by this member can be suppressed, and hence the reduction in the quality of the projected image can be effectively suppressed.

In the aforementioned projector system according to the first aspect, the control portion of the projector is preferably configured such that the image projected by the light projection portion follows movement of the mirror portion on the basis of the positional information of the mirror portion acquired from the light reflector. According to this structure, the image can be projected continuously on the mirror portion on the basis of the positional information of the moving mirror portion even if the position of the mirror portion is changed.

In the aforementioned projector system according to the first aspect, the position detecting portion preferably includes an encoder, the light reflector preferably includes a mirror fixing member on which a plurality of mirror portions rotatable about a rotation axis are set, the drive portion of the light reflector is preferably configured to rotate the mirror fixing member about the rotation axis, and the control portion of the projector is preferably configured to be capable of acquiring information about the rotation angle of the mirror fixing member detected by the encoder of the light reflector and switch the image projected by the projector on the basis of the information about the rotation angle of the mirror fixing member. According to this structure, even when the plurality of mirror portions are set, the positional information of the plurality of mirror portions can be easily acquired simply by acquiring the rotation angle of the mirror fixing member from the encoder if the positional information of each of the plurality of mirror portions in the mirror fixing member is previously grasped.

In this case, the drive portion is preferably configured to be capable of changing the rotation speeds of the mirror portions, and the control portion of the projector is preferably configured to switch the image projected by the projector in synchronization with rotation of the mirror portions on the basis of information about the rotation speeds of the mirror portions that are changed when the rotation speeds of the mirror portions are changed. According to this structure, the image can be reliably projected on the mirror portions following the change in the speeds even in the case where the rotation speeds of the mirror portions can be changed, and hence the reduction in the quality of the projected image can be suppressed.

In the aforementioned projector system according to the first aspect, the projector preferably includes a storage portion storing a table in which the movement position of the mirror portion and an image corresponding to the movement position of the mirror portion are associated with each other, and the control portion of the projector is preferably configured to switch the image projected by the projector on the basis of information about the rotation speed of the mirror portion and information in the table. According to this structure, the load on control can be reduced by employing the table in which the movement position of the mirror portion and the image corresponding to the movement position of the mirror portion are associated with each other, unlike the case where the image corresponding to the movement position of the mirror portion is generated in real time.

In this case, the table is preferably configured to associate the image corresponding to not only the movement position of the mirror portion but also the inclination angle of the mirror portion at the movement position of the mirror portion with the movement position of the mirror portion. According to this structure, the image corresponding to both the position of the mirror portion and the inclination angle of the mirror portion at the movement position of the mirror portion can be projected, and hence in addition to the suppression of the separation (breaks) of the image reflected by the mirror portion on the wall surface or the like, distortion of the image reflected by the mirror portion resulting from the inclination of the mirror portion can be suppressed.

In the case where the table is configured to associate the image corresponding to not only the movement position of the mirror portion but also the inclination angle of the mirror portion at the movement position of the mirror portion with the movement position of the mirror portion, the table is preferably configured to associate the image distorted according to the inclination angle of the mirror portion with the movement position of the mirror portion. According to this structure, the distortion of the image reflected by the mirror portion can be easily suppressed by previously distorting the projected image to correspond to the inclination of the mirror portion.

In the aforementioned structure including the storage portion, the drive portion is preferably configured to rotate the mirror portion by a prescribed rotation pitch angle, and the table is preferably configured to include images corresponding in number to a number obtained by dividing 360 degrees by he prescribed rotation pitch angle. According to this structure, an image corresponding to the mirror portion arranged at a position separated by the prescribed rotation pitch angle of the drive portion can be projected. Thus, the image can be accurately switched and projected according to the position of the mirror portion.

In the aforementioned structure including the mirror fixing member on which the plurality of mirror portions are set, the plurality of mirror portions preferably have substantially the same size, and the control portion of the projector is preferably configured to switch the image scanned by the light scanning portion such that the light is emitted to each of the mirror portions on the basis of the positional information of each of the mirror portions in substantially the same size. According to this structure, the size of the image projected on each of the mirror portions may not be changed, unlike the case where the plurality of mirror portions are different in size. Consequently, the separation of images reflected by the mirror portions on the projection surface such as the wall surface can be easily suppressed.

In the aforementioned projector system according to the first aspect, a light source of the projector preferably includes a laser beam source, the mirror portion preferably has a reflecting surface, the reflecting surface is preferably formed such that the vicinity of a central portion thereof is recessed with respect to the vicinity of an edge thereof, and the mirror portion is preferably configured to reflect a laser beam constituting the image projected by the projector to the prescribed region by the reflecting surface that is recessed. According to this structure, diffusion (blur) of the image reflected by the mirror portion on the projection surface such as the wall surface can be suppressed, and hence a clear image can be projected. In the aforementioned projector system according to the first aspect, the light reflector preferably includes a light detecting portion configured to set the reference position of the light reflector by detecting the light emitted from the projector. According to this structure, the reference position of the light reflector can be accurately set. Consequently, the image can be accurately projected on the mirror portion even if the position of the mirror portion is changed.

In the aforementioned structure including the mirror fixing member on which the plurality of mirror portions are set, the control portion of the projector is preferably configured to switch images to allow a plurality of images projected on the plurality of mirror portions to revolve about the center of the plurality of mirror portions as a revolution center in synchronization with movement of the plurality of mirror portions on the basis of the positional information of the plurality of mirror portions and switch the images to allow the plurality of images projected on the plurality of mirror portions to independently rotate about the centers of the plurality of mirror portions as rotation centers on the basis of the positional information of the plurality of mirror portions. According to this structure, the plurality of mirror portions can rotate while the images are projected (revolved) in synchronization with the movement of the plurality of mirror portions. Consequently, patterns of the movement of the projected images can be increased while the separation of the images reflected by the mirror portions on the projection surface such as the wall surface is suppressed.

In the aforementioned structure including the storage portion, the projector and the light reflector are preferably fixedly arranged at a prescribed interval therebetween, and the control portion of the projector is preferably configured to project the image on the light reflector while switching the image on the basis of the information in the table and the positional information of the mirror portion. According to this structure, an intended image can be accurately projected while the same is moved to an intended position, employing the information in the table and the positional information of the mirror portion.

In the aforementioned projector system according to the first aspect, a plurality of projectors are preferably provided, and the light reflector is preferably arranged at a substantially central position between the plurality of projectors. According to this structure, the plurality of projectors can project images on a larger projection surface while the separation of the image reflected by the mirror portion on the projection surface such as the wall surface is suppressed.

In the aforementioned projector system according to the first aspect, the projector preferably includes a portable mobile projector, the light reflector preferably includes a portable mobile light reflector, the light reflector preferably includes a plurality of mirror portions, and the plurality of mirror portions are preferably arranged such that reflecting surfaces thereof are substantially parallel to each other. According to this structure, the image can be projected on the projection surface in a prescribed direction by the light reflector. Thus, a user can easily utilize this projector system by arranging the projector and the light reflector at an arbitrary place and projecting the image on the wall surface or the like in the vicinity of the arbitrary place, for example.

In the aforementioned structure including the mirror fixing member on which the plurality of mirror portions are set, the mirror fixing member preferably has a substantially spherical shape or a substantially circular plate shape. According to this structure, the image can be easily rotated while the separation of the image reflected by the mirror portion on the projection surface is suppressed.

A projector according to a second aspect of the present invention includes a light projection portion projecting an image and a control portion, and the control portion is preferably configured to acquire positional information of a movable mirror portion from a light reflector reflecting light constituting the image that is projected to a prescribed region, including the movable mirror portion and switch the image projected from the light projection portion on the basis of the positional information of the movable mirror portion.

As hereinabove described, the projector according to the second aspect of the present invention is provided with the control portion acquiring the positional information of the moving mirror portion from the light reflector and switching the image projected by the projector on the basis of the positional information of the moving mirror portion, whereby the image can be reliably projected on the mirror portion on the basis of the positional information of the moving mirror portion even if the position of the mirror portion is changed, and hence separation (breaks) of the image reflected by the mirror portion on a projection surface such as a wall surface can be suppressed. Consequently, a reduction in the quality of the image projected by the moving mirror portion can be suppressed.

According to the present invention, as hereinabove described, the reduction in the quality of the image projected by the moving mirror portion can be suppressed.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic view showing a projector system according to a first embodiment of the present invention;

FIG. 2 is a block diagram showing the projector system according to the first embodiment of the present invention;

FIG. 3 is a diagram showing a table employed to project an image in the projector system according to the first embodiment of the present invention;

FIG. 4 is a diagram showing a mirror ball arranged at a reference position in the projector system according to the first embodiment of the present invention;

FIG. 5 is a diagram showing the mirror ball rotated by 45 degrees from the reference position in the projector system according to the first embodiment of the present invention;

FIG. 6 is a flowchart for illustrating projection processing performed by the projector system according to the first embodiment of the present invention;

FIG. 7 is a schematic view showing a projector system according to a second embodiment of the present invention; and

FIG. 8 is a schematic view showing a projector system according to a third embodiment of the present invention.

### DESCRIPTION OF THE PREFERRED EMBODIMENTS

Embodiments of the present invention are hereinafter described with reference to the drawings.

### First Embodiment

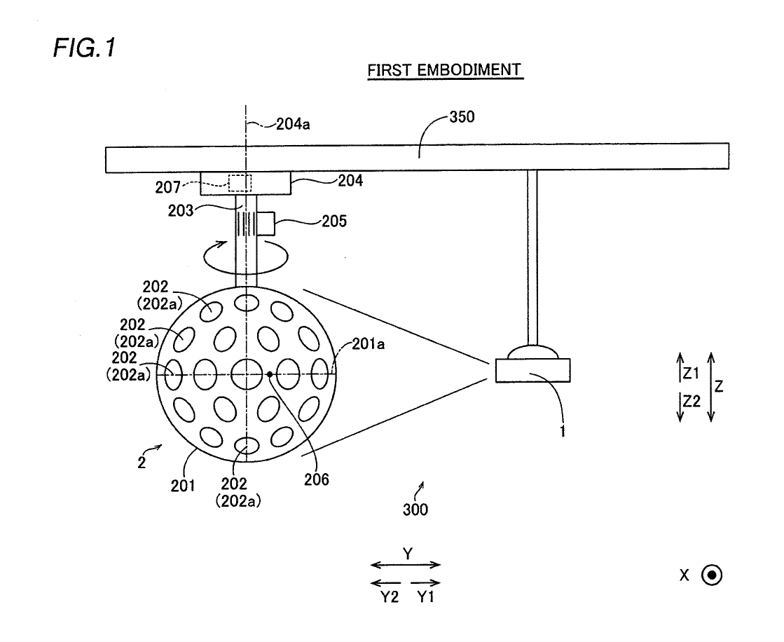

The structure of a projector system 300 according to a first embodiment of the present invention is now described with reference to FIGS. 1 to 5.

The projector system 300 according to the first embodiment of the present invention includes a projector 1 and a mirror ball 2, as shown in FIG. 1. In this projector system 300, light constituting an image (an image of stars, for example (see FIG. 5)) projected from the projector 1 is reflected by a plurality of mirror portions 202, described later, of the mirror ball 2, whereby reflected light (image) is projected (swept) on a wall surface or the like. The projector 1 and the mirror ball 2 are set on a ceiling 350 of a theater, a dance hall, or the like, for example. Furthermore, the projector 1 and the mirror ball 2 are fixedly arranged at a previously determined interval in a transverse direction (horizontal direction). One projector 1 is provided on one side (Y1 side, for example) of the mirror ball 1. An interval from the projector 1 to the ceiling 350 in a vertical direction (direction Z) is substantially equal to an interval from an equator line 201a, described later, of the mirror ball 2 to the ceiling 350. In other words, the projector 1 and the mirror ball 2 (equator line 201a) are arranged at substantially the same height. The mirror ball 2 is an example of the “light reflector” in the present invention.

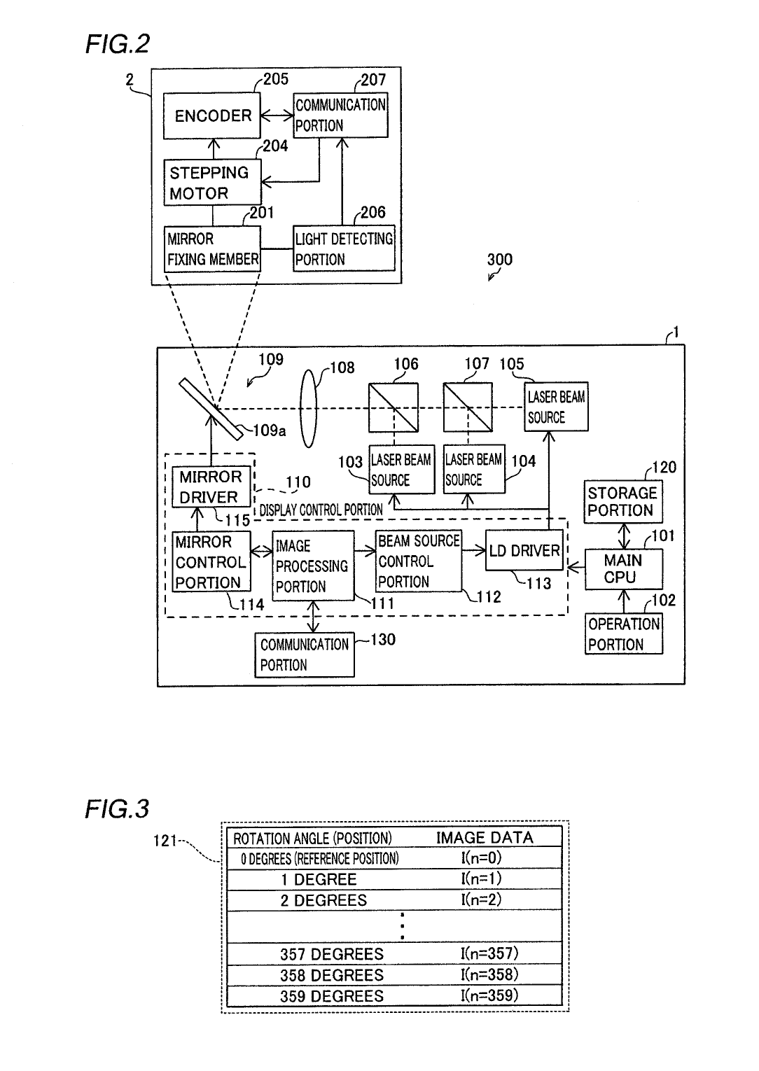

The projector 1 includes a main CPU 101, an operation portion 102, three (three colors (blue, green, and red)) laser beam sources 103 to 105, two beam splitters 106 and 107, a lens 108, a laser beam scanning portion 109, a display control portion 110, a storage portion 120, and a communication portion 130, as shown in FIG. 2. The image projected on the mirror ball 2 is formed by the laser beam sources 103 to 105. The laser beam scanning portion 109 includes a MEMS (Micro Electro Mechanical System) mirror 109a. The laser beam scanning portion 109 scans a laser beam on the mirror ball 2 (mirror portions 202) to project the image on a projection area such as the wall surface. The laser beam scanning portion 109 is an example of the “light projection portion” or the “light scanning portion” in the present invention.

According to the first embodiment, the mirror ball 2 includes a mirror fixing member 201, the mirror portions 202, a supporting portion 203, a stepping motor 204, an encoder 205, a light detecting portion 206, and a communication portion 207, as shown in FIG. 1. The stepping motor 204 is an example of the “drive portion” in the present invention. The encoder 205 is an example of the “position detecting portion” in the present invention.

The mirror fixing member 201 has a substantially spherical shape. On a surface of the mirror fixing member 201, the plurality of mirror portions 202 are arranged.

The mirror portions 202 are configured to reflect the light constituting the image projected by the projector 1 to the wall surface or the like. The mirror portions 202 each have a substantially circular shape. The plurality of mirror portions 202 are formed in substantially the same shape. Furthermore, the plurality of mirror portions 202 are formed in substantially the same size. The plurality of mirror portions 202 are arranged such that intervals between adjacent mirror portions 202 are equal to each other. The mirror portions 202 are formed such that central portions of reflecting surfaces 202a are recessed with respect to edges thereof. In other words, the mirror portions 202 (reflecting surfaces 202a) each have a concave cross-sectional shape. More specifically, the mirror portions 202 are formed such that the cross-sections thereof each are in the form of a concave lens (concavely curved).

A first end of the supporting portion 203 is fixed to the mirror fixing member 201, and a second end thereof is rotatably mounted on the stepping motor 204. Thus, the mirror fixing member 201 is arranged (hung) at a position separated from the ceiling 350 by the length of the supporting portion 203.

The stepping motor 204 is configured to rotate the mirror fixing member 201 clockwise as viewed from the ceiling 350 (Z1 side). The stepping motor 204 is configured to rotate the mirror fixing member 201 about a rotation axis 204a (supporting portion 203). Thus, the plurality of mirror portions 202 set on the mirror fixing member 201 are rotated (moved) about the rotation axis 204a. The stepping motor 204 is configured to be capable of changing a rotation speed. Thus, the rotation speeds of the mirror portions 202 (mirror fixing member 201) can be changed. Furthermore, the stepping motor 204 is configured to rotate by a prescribed rotation pitch angle (at one degree angular intervals, for example).

The encoder 205 is configured to detect the positions of the mirror portions 202 (mirror fixing member 201). Specifically, the encoder 205 detects the rotation of the stepping motor 204 to detect the rotation angle of the mirror fixing member 201 (i.e. the positions of the mirror portions 202) with respect to the projector 1. The encoder 205 consists of an incremental encoder detecting the relative position of the mirror fixing member 201.

The light detecting portion 206 includes a photodiode. The light detecting portion 206 is configured to detect reference position (position in an initial state) setting light emitted from the projector 1. The light detecting portion 206 is arranged on the equator line 201a of the mirror ball 2 (mirror fixing member 201). Light intensity (the light intensity of the reference position setting light) detected by the light detecting portion 206 is maximized in a state where the light detecting portion 206 is arranged in front of the projector 1 (a state where the light detecting portion 206 and the projector 1 are opposed to each other). In other words, the light intensity detected by the light detecting portion 206 is maximized when a distance from the light detecting portion 206 to the projector 1 is the shortest.

The communication portion 207 is configured to transmit/receive information (data) to/from the projector 1 wirelessly. More specifically, the communication portion 207 is configured to transmit (transfer) the position (rotation angle) of the mirror fixing member 201 (mirror portions 202) with respect to the projector 1 detected by the encoder 205 to the projector 1. Furthermore, the communication portion 207 is configured to receive a control signal for controlling the rotation of the stepping motor 204 from the projector 1.

Each part of the projector 1 is now described in detail.

As shown in FIG. 2, the main CPU 101 is configured to control each part of the projector 1. The operation portion 102 is provided to accept operations of turning on the projector 1, changing the resolution of the image, etc.

The laser beam source 103 is configured to emit a blue laser beam to the MEMS mirror 109a through the beam splitter 106 and the lens 108. The laser beam sources 104 and 105 are configured to emit a green laser beam and a red laser beam, respectively, to the MEMS mirror 109a through the beam splitters 107 and 106 and the lens 108.

The laser beam scanning portion 109 is configured to project the laser beams on the mirror ball 2. Specifically, the MEMS mirror 109a of the laser beam scanning portion 109 is configured to scan the laser beams emitted from the laser beam sources 103 to 105 and project the image on the mirror ball 2 (mirror portions 202). The MEMS mirror 109a is configured to be driven in two directions (two axes) of a horizontal direction (direction X) and a vertical direction (direction Z) and scan the laser beams. The MEMS mirror 109a is configured to scan the horizontal direction at a high speed by resonance driving and to scan the vertical direction at a low speed by DC driving.

The display control portion 110 includes an image processing portion 111, a beam source control portion 112, an LD (laser diode) driver 113, a mirror control portion 114, and a mirror driver 115. The projector 1 is configured to output an image on the basis of image data stored in the storage portion 120. The image processing portion 111 is an example of the “control portion” in the present invention.

The image processing portion 111 is constituted by a CPU performing a logical operation, a ROM (Read Only Memory) storing a program controlling the CPU etc., a RAM (Random Access Memory) temporarily storing various types of data during the operation of the apparatus, etc. The image processing portion 111 is described later in detail.

The beam source control portion 112 is configured to control the LD driver 113 on the basis of control performed by the image processing portion 111 and control the emission of the laser beams from the laser beam sources 103 to 105. Specifically, the beam source control portion 112 is configured to control the laser beam sources 103 to 105 to emit the laser beams of colors corresponding to pixels of the image in synchronization with the scanning timing of the MEMS mirror 109a.

The mirror control portion 114 is configured to control the mirror driver 115 on the basis of control performed by the image processing portion 111 and control the driving of the MEMS mirror 109a.

The storage portion 120 includes a non-volatile memory. The storage portion 120 stores a table 121 (see FIG. 3) in which the movement positions of the mirror portions 202 and image data (I (n=0) to I (n=359)) corresponding to the inclination angles of the mirror portions 202 at the movement positions of the mirror portions 202 are associated with the respective movement positions of the mirror portions 202. In other words, the table 121 includes image data corresponding in number to a number obtained by dividing 360 degrees by the prescribed rotation pitch angle of the stepping motor 204.

Employing this image data, an image is projected on the position of each of the plurality of mirror portions 202 from the projector I. More specifically, this image data is configured such that an image is projected on the positions of the plurality of mirror portions 202 from the projector 1 when the stepping motor 204 rotates (rotates at one degree angular intervals from 0 degrees to 359 degrees). Thus, the projector 1 can project the image on the mirror portions 202 following the rotation of the mirror portions 202 (mirror fixing member 201).

This image data is configured such that the image reflected by the plurality of mirror portions 202 is projected on the wall surface or the like without distortion. More specifically, in an example shown in FIG. 5, the image data is configured such that an image (an image of a undistorted star) in substantially the same shape as the image projected on the wall surface is projected on a mirror portion 202 arranged at a position A in front of the projector 1 from the projector 1. On the other hand, the image data (table) is configured such that an image (an image of a distorted star) distorted according to the inclination angle of a mirror portion 202 at a position B is projected on the mirror portion 202 arranged at a position (the position B, for example) distanced from the position A from the projector 1, unlike the image projected on the mirror portion 202 arranged at the position A.

The communication portion 130 is configured to transmit/receive information (data) to/from the communication portion 207 of the mirror ball 2 wirelessly.

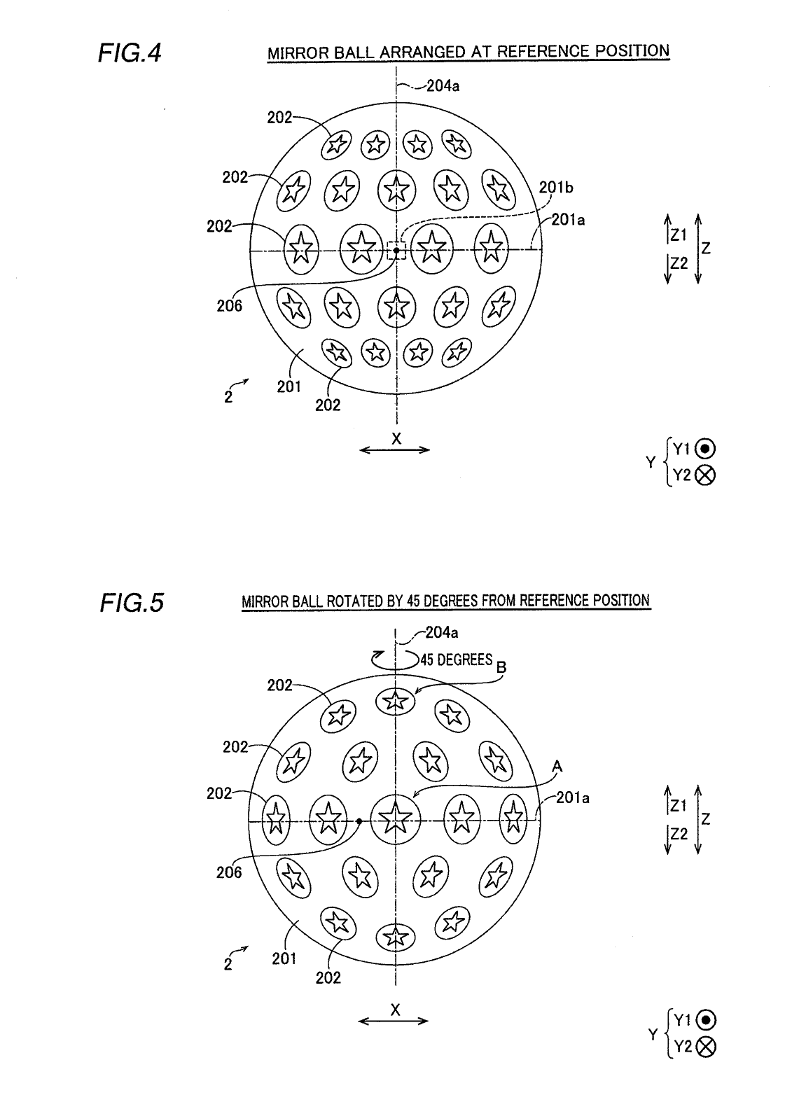

According to the first embodiment, the image processing portion 111 is configured to move (rotate) the mirror fixing member 201 to a position where the light detecting portion 206 is arranged in front of the mirror fixing member 201 (a position where the distance from the light detecting portion 206 to the projector 1 is the shortest) when detecting that the light intensity detected by the light detecting portion 206 of the mirror ball 2 is maximized. This control is performed when the projector 1 (projector system 300) starts to be used (before the projector 1 (projector system 300) starts projection). Thus, the mirror fixing member 201 is arranged at the position (reference position) in the initial state shown in FIG. 4.

According to the first embodiment, the image processing portion 111 is configured to control projection of the image on the basis of the image data stored in the storage portion 120. More specifically, the image processing portion 111 is configured to control the driving of the MEMS mirror 109a through the mirror control portion 114 on the basis of the image data in the table 121. Furthermore, the image processing portion 111 is configured to control the emission of the laser beams from the laser beam sources 103 to 105 through the beam source control portion 112.

The image processing portion 111 is configured to acquire positional information of the mirror portions 202 from the mirror ball 2 by communication through the communication portion 130 and the communication portion 207. Furthermore, the image processing portion 111 is configured to receive information transmitted from the mirror ball 2 through the communication portion 130. More specifically, the image processing portion 111 is configured to receive the position of the mirror fixing member 201 (mirror portions 202) with respect to the projector 1 detected by the encoder 205 from the mirror ball 2 (communication portion 207).

The image processing portion 111 is configured to switch the image projected by the projector 1 in synchronization with the movement of the mirror portions 202 on the basis of the acquired positional information of the mirror portions 202. Specifically, the image processing portion 111 is configured to be capable of acquiring information about the rotation angles of the mirror portions 202 detected by the encoder 205 of the mirror ball 2. The image processing portion 111 is configured to calculate the actual movement speeds of the mirror portions 202 from the information about the rotation angles (positional information) of the mirror portions 202 and switch the image projected by the projector 1 in synchronization with the movement of the mirror portions 202 on the basis of the calculated movement speeds. Thus, the image processing portion 111 is configured to switch the image projected by the projector 1 in synchronization with the timing of the rotation of the mirror portions 202 (mirror fixing member 201). Furthermore, the image processing portion 111 is configured to control the driving of the stepping motor 204 by transmitting the control signal for controlling the rotation of the stepping motor 204 to the mirror ball 2 and control the rotation operation of the mirror fixing member 201 (mirror portions 202).

The image processing portion 111 is configured to switch the image projected by the projector 1 in synchronization with the rotation of the mirror portions 202 on the basis of information about the changed rotation speeds of the mirror portions 202 when the rotation speeds of the mirror portions 202 (mirror fixing member 201) are changed. In other words, the image processing portion 111 can switch the image projected by the projector 1 quickly if the rotation speeds of the mirror portions 202 are increased and switch the image projected by the projector 1 slowly if the rotation speeds of the mirror portions 202 are reduced. The rotation speeds of the mirror portions 202 are changed on the basis of an operation performed on the image processing portion 111 through the operation portion 102 by a user.

The image processing portion 111 is configured to switch the image projected by the projector 1 on the basis of information about the rotation speeds of the mirror portions 202 and information in the table 121. The image processing portion 111 is configured to perform control of emitting the light constituting the image (the image of the stars in FIG. 5) to the plurality of mirror portions 202 at the reference position on the basis of the image data I (n=0) (see FIG. 3) in the table 121 when the mirror portions 202 (mirror fixing member 201) are arranged at the position in the initial state (reference position), as shown in FIG. 4, for example. Furthermore, the image processing portion 111 is configured to perform control of emitting the light constituting the image to the plurality of mirror portions 202 in the following state on the basis of the image data I (n=45) (see FIG. 3) in the table 121 when the mirror portions 202 (mirror fixing member 201) are arranged at a position where the mirror portions 202 (mirror fixing member 201) are rotated by 45 degrees clockwise from the position in the initial state (reference position), as shown in FIG. 5. Thus, the image (the projection positions of the stars in the image) projected from the projector 1 is synchronized with (follows) the rotation (movement) of the mirror portions 202.

The image processing portion 111 is configured to acquire the positional information of the mirror portions 202 from the mirror ball 2 and switch the image scanned by the laser beam scanning portion 109 (MEMS mirror 109a) such that the light is emitted only to the mirror portions 202 (control the laser beam sources 103 to 105 to project the image only on the mirror portions 202) on the basis of the positional information of the mirror portions 202. In other words, the image processing portion 111 is configured to perform control of emitting no light on a surface of the mirror fixing member 201 provided with no mirror portion 202 on the basis of the positional information of the mirror portions 202.

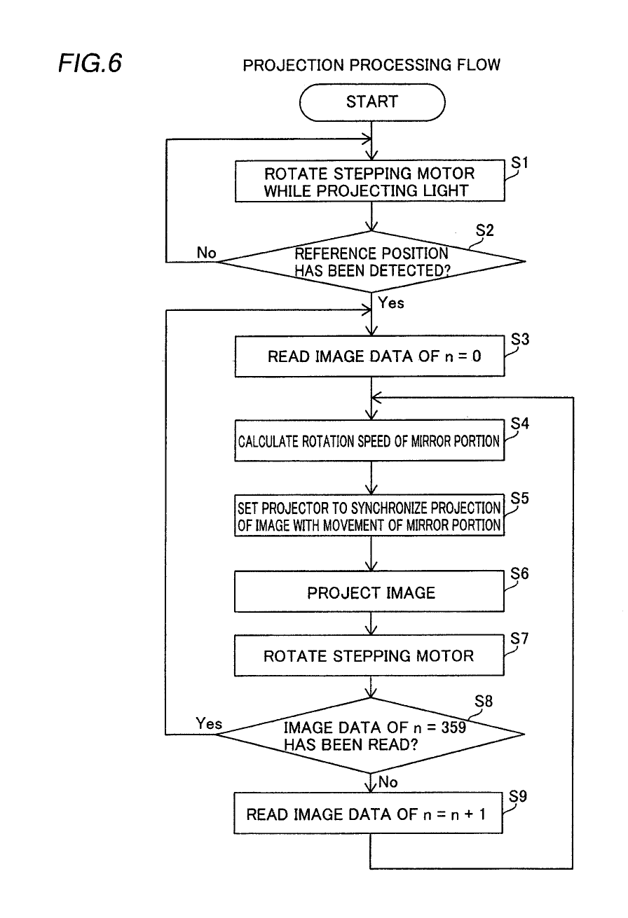

Projection processing performed by the image processing portion 111 of the projector 1 in the projector system 300 according to the first embodiment is now described with reference to FIGS. 3, 4, and 6. This projection processing is performed by the image processing portion 111 of the projector 1.

First, the stepping motor 204 is rotated while the light is projected at a step S1. More specifically, the stepping motor 204 is rotated while the reference position (the position in the initial state) setting light is projected to a region 201b (see FIG. 4) of the mirror ball 2 opposed to the projector 1 in the vicinity of the equator line 201a from the projector 1.

Then, the image processing portion 111 determines whether or not the reference position has been detected at a step S2. More specifically, the image processing portion 111 determines whether or not the light intensity detected by the light detecting portion 206 of the mirror ball 2 is maximized. When determining that the light intensity detected by the light detecting portion 206 is not maximized, the image processing portion 111 returns to the step S1. When determining that the light intensity detected by the light detecting portion 206 is maximized, on the other hand, the imaging processing portion 2 stops the rotation of the mirror ball 2 and determines the stop position as the reference position of the mirror ball 2.

Then, the image processing portion 111 reads the image data of n=0 at a step S3. More specifically, the image processing portion 111 reads the image data for projecting the image corresponding to the mirror ball 2 (mirror portions 202) at the reference position from the table 121 (see FIG. 3).

Then, the image processing portion 111 calculates the rotation speeds of the mirror portions 202 at a step S4. More specifically, the image processing portion 111 calculates the rotation speeds of the mirror portions 202 on the basis of a change in the positional information of the stepping motor 204 (mirror portions 202) acquired from the mirror ball 2.

Then, the image processing portion 111 sets the projector 1 to synchronize the projection of the image with the movement of the mirror portions 202 at a step S5. More specifically, the image processing portion 111 sets the projector 1 performing an image projection (switching) operation to project the image to be projected in synchronization with (following) the movement of the mirror portions 202. Image projection control (steps S3 to S9) based on the rotation speeds of the mirror portions 202 is performed by the control at these steps S4 and S5.

Then, the image processing portion 111 projects the image at a step S6. More specifically, the image processing portion 111 projects the image on the mirror fixing member 201 (mirror portions 202) from the projector 1 on the basis of the setting performed at the step S5 employing the image data read from the table 121 at the step S3 or a step S9 described later.

Then, the stepping motor 204 is rotated at a step S7. More specifically, the stepping motor 204 is controlled such that the mirror fixing member 201 is rotated by 1 degree as viewed from the ceiling 350 (Z1 side).

Then, the image processing portion 111 determines whether or not the image data of n=359 has been read at a step S8. When determining that the image data of n=359 has been read (the mirror ball 2 has rotated one revolution), the image processing portion 111 returns to the step S3. When determining that the image data of n=359 has not been read, on the other hand, the image processing portion 111 advances to the step S9.

At the step S9, the image processing portion 111 reads image data of n=n+1. Then, the image processing portion 111 returns to the step S4.

The undistorted or unseparated (unbroken) image is projected on the projection surface such as the wall surface by the aforementioned control at the steps S1 to S9. Once the reference position of the mirror ball 2 is determined by the processing at the steps S1 and S2, the processing at the steps S3 to S9 is repetitively performed during the operation of the projector system 300.

According to the aforementioned first embodiment, the following effects can be obtained.

According to the first embodiment, as hereinabove described, the projector system 300 is provided with the image processing portion 111 of the projector 1 acquiring the positional information of the moving mirror portions 202 from the mirror ball 2 and switching the image projected by the projector 1 on the basis of the positional information of the moving mirror portions 202. Thus, the image can be reliably projected on the mirror portions 202 on the basis of the positional information of the moving mirror portions 202 even if the positions of the mirror portions 202 are changed, and hence separation (breaks) of the image reflected by the mirror portions 202 on the projection surface such as the wall surface can be suppressed. Consequently, a reduction in the quality of the image projected by the moving mirror portions 202 can be suppressed.

According to the first embodiment, as hereinabove described, the image processing portion 111 of the projector 1 is configured to switch the image projected by the projector 1 in synchronization with the movement of the mirror portions 202 on the basis of the positional information of the mirror portions 202. Thus, the image can be projected to accommodate the movement of the mirror portions 202 on the basis of the positional information of the mirror portions 202 even if the positions of the mirror portions 202 are changed, and hence the separation (breaks) of the image reflected by the moving mirror portions 202 on the projection surface such as the wall surface can be effectively suppressed.

According to the first embodiment, as hereinabove described, the image processing portion 111 of the projector 1 is configured to calculate the movement speeds of the mirror portions 202 from the positional information of the mirror portions 202 and switch the image projected by the projector 1 in synchronization with the movement of the mirror portions 202 on the basis of the calculated movement speeds. Thus, the image can be easily projected to accommodate the movement of the mirror portions 202, employing information about the speeds of the mirror portions 202.

According to the first embodiment, as hereinabove described, the image processing portion 111 of the projector 1 is configured to acquire the positional information of the mirror portions 202 from the mirror ball 2 and switch the image scanned by the laser beam scanning portion 109 such that the light is emitted only to the mirror portions 202 on the basis of the positional information of the mirror portions 202. Thus, even if a member having high reflectance is provided outside (around) the mirror portions 202, for example, unintended reflection of the light by this member can be suppressed, and hence the reduction in the quality of the projected image can be effectively suppressed.

According to the first embodiment, as hereinabove described, the image processing portion 111 of the projector 1 is configured such that the image projected by the laser beam scanning portion 109 follows the movement of the mirror portions 202 on the basis of the positional information of the mirror portions 202 acquired from the mirror ball 2. Thus, the image can be projected continuously on the mirror portions 202 on the basis of the positional information of the moving mirror portions 202 even if the positions of the mirror portions 202 are changed.

According to the first embodiment, as hereinabove described, the position detecting portion includes the encoder 205, the projector system 300 is provided with the mirror fixing member 201 on which the plurality of mirror portions 202 rotatable about the rotation axis 204a are set, and the stepping motor 204 is configured to rotate the mirror fixing member 201 about the rotation axis 204a. Furthermore, the image processing portion 111 of the projector 1 is configured to be capable of acquiring the information about the rotation angle of the mirror fixing member 201 detected by the encoder 205 of the mirror ball 2 and switch the image projected by the projector 1 on the basis of the information about the rotation angle of the mirror fixing member 201. Thus, even when the plurality of mirror portions 202 are set, the positional information of the plurality of mirror portions 202 can be easily acquired simply by acquiring the rotation angle of the mirror fixing member 201 from the encoder 205 if the positional information of each of the plurality of mirror portions 202 in the mirror fixing member 201 is previously grasped.

According to the first embodiment, as hereinabove described, the stepping motor 204 is configured to be capable of changing the rotation speeds of the mirror portions 202, and the image processing portion 111 of the projector 1 is configured to switch the image projected by the projector 1 in synchronization with the rotation of the mirror portions 202 on the basis of the information about the changed rotation speeds of the mirror portions 202 when the rotation speeds of the mirror portions 202 are changed. Thus, the image can be reliably projected on the mirror portions 202 following the change in the speeds even in the case where the rotation speeds of the mirror portions 202 can be changed, and hence the reduction in the quality of the projected image can be suppressed.

According to the first embodiment, as hereinabove described, the projector 1 is provided with the storage portion 120 storing the table 121 in which the movement positions of the mirror portions 202 and images corresponding to the respective movement positions of the mirror portions 202 are associated with each other, and the image processing portion 111 of the projector 1 is configured to switch the image projected by the projector 1 on the basis of the information about the rotation speeds of the mirror portions 202 and the information in the table 121. Thus, the load on control can be reduced by employing the table 121 in which the movement positions of the mirror portions 202 and the images corresponding to the respective movement positions of the mirror portions 202 are associated with each other, unlike the case where the images corresponding to the respective movement positions of the mirror portions 202 are generated in real time.

According to the first embodiment, as hereinabove described, the table 121 is configured to associate the images corresponding to not only the movement positions of the mirror portions 202 but also the inclination angles of the mirror portions 202 at the movement positions of the mirror portions 202 with the respective movement positions of the mirror portions 202. Thus, the images corresponding to both the positional information of the mirror portions 202 and the inclination angles of the mirror portions 202 at the movement positions of the mirror portions 202 can be projected, and hence in addition to the suppression of the separation (breaks) of the image reflected by the mirror portions 202 and projected on the wall surface or the like, distortion of the image reflected by the mirror portions 202 resulting from the inclination of the mirror portions 202 can be suppressed.

According to the first embodiment, as hereinabove described, the table 121 is configured to associate the images distorted according to the inclination angles of the mirror portions 202 and the movement positions of the mirror portions 202 with each other. Thus, the distortion of the image reflected by the mirror portions 202 can be easily suppressed by previously distorting the projected image to correspond to the inclination of the mirror portions 202.

According to the first embodiment, as hereinabove described, the table 121 is configured to include images corresponding in number to the number obtained by dividing 360 degrees by the prescribed rotation pitch angle of the stepping motor 204. Thus, images corresponding to the mirror portions 202 arranged at positions separated by the prescribed rotation pitch angle of the stepping motor 204 can be projected.

According to the first embodiment, as hereinabove described, the image processing portion 111 of the projector 1 is configured to switch the image scanned by the laser beam scanning portion 109 such that the light is emitted to each of the mirror portions 202 on the basis of the positional information of each of the mirror portions 202 in substantially the same size. Thus, the size of the image projected on each of the mirror portions 202 may not be changed, unlike the case where the plurality of mirror portions 202 are different in size. Consequently, the separation of the image reflected by the mirror portions 202 on the projection surface such as the wall surface can be easily suppressed.

According to the first embodiment, as hereinabove described, a light source of the projector 1 includes the laser beam sources 103 to 105, the reflecting surfaces 202a of the mirror portions 202 are formed such that the vicinities of central portions thereof are recessed with respect to the vicinities of edges thereof, and the mirror portions 202 are configured to reflect the laser beam constituting the image projected by the projector 1 to the prescribed region by the recessed reflecting surfaces 202a. Thus, diffusion (blur) of the image reflected by the mirror portions 202 on the projection surface such as the wall surface can be suppressed, and hence a clear image can be projected.

According to the first embodiment, as hereinabove described, the mirror ball 2 is configured to include the light detecting portion 206 configured to set the reference position of the mirror ball 2. Thus, the reference position of the mirror ball 2 can be accurately set. Consequently, the image can be accurately projected on the mirror portions 202 even if the positions of the mirror portions 202 are changed.

According to the first embodiment, as hereinabove described, the image processing portion 111 is configured to project the image on the mirror ball 2 while switching the image on the basis of the information in the table 121 and the positional information of the mirror portions 202. Thus, an intended image can be accurately projected while the same is moved to an intended position, employing the information in the table 121 and the positional information of the mirror portions 202.

According to the first embodiment, as hereinabove described, the mirror fixing member 201 is formed in the substantially spherical shape. Thus, the image can be easily rotated while the separation of the image reflected by the mirror portions 202 on the projection surface is suppressed.

### Second Embodiment

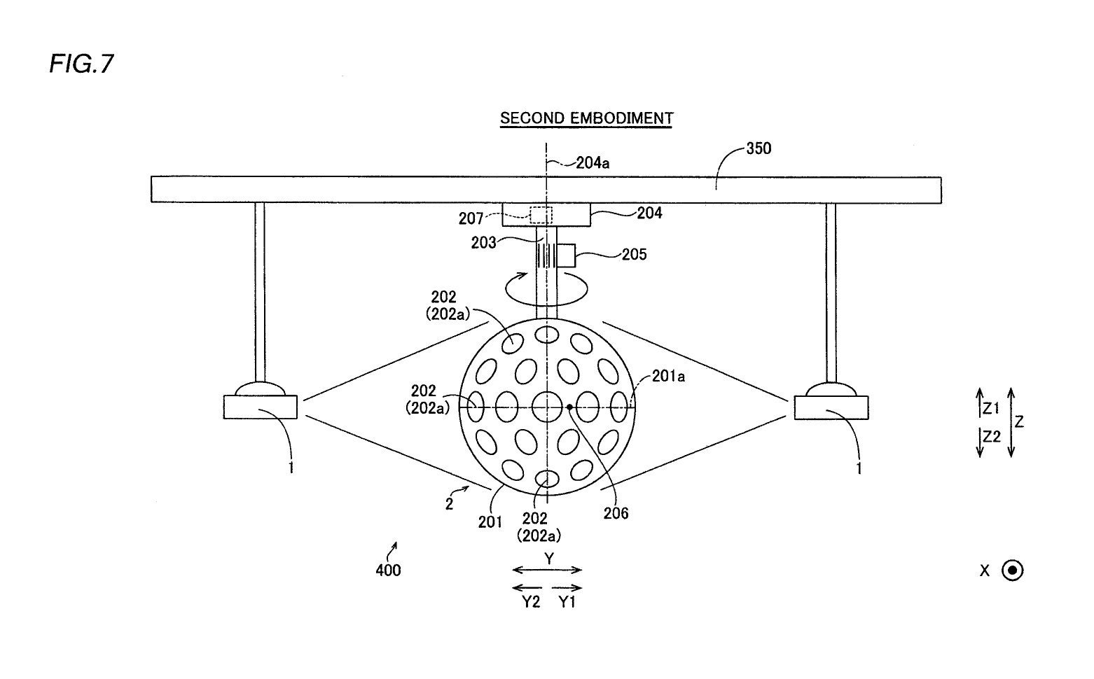

The structure of a projector system 400 according to a second embodiment of the present invention is now described with reference to FIG. 7.

In this second embodiment, the projector system 400 configured to project light forming an image on a mirror ball 2 from two projectors 1 is described unlike the first embodiment showing an example of projecting the light forming the image on the mirror ball 2 from the single projector 1.

In the projector system 400 according to the second embodiment, the two projectors 1 are arranged at a previously determined interval therebetween. Furthermore, the mirror ball 2 is arranged at a substantially central position between the two projectors 1. The two projectors 1 and the mirror ball 2 are arranged substantially linearly as viewed from above. The two projectors 1 and the mirror ball 2 (equator line 201a) are arranged at substantially the same height.

The projector system 400 is configured to project an image on the Y1 side of the mirror ball 2 by a projector 1 arranged on the Y1 side and project an image on the Y2 side of the mirror ball 2 by a projector 1 arranged on the Y2 side.

The remaining structure of the projector system 400 according to the second embodiment is similar to that of the projector system 300 according to the aforementioned first embodiment.

According to the aforementioned second embodiment, the following effects can be obtained.

According to the second embodiment, as hereinabove described, the projector system 400 is provided with image processing portions 111 of the projectors 1 acquiring the positional information of moving mirror portions 202 from the mirror ball 2 and switching the images projected by the projectors 1 on the basis of the positional information of the moving mirror portions 202. Thus, the images can be reliably projected on the mirror portions 202 on the basis of the positional information of the moving mirror portions 202 even if the positions of the mirror portions 202 are changed, and hence separation (breaks) of the images reflected by the mirror portions 202 on a projection surface such as a wall surface can be suppressed. Consequently, a reduction in the quality of the images projected by the moving mirror portions 202 can be suppressed.

According to the second embodiment, as hereinabove described, the projector system 400 is configured such that the mirror ball 2 is arranged at the substantially central position between the two projectors 1. Thus, the light projected from the two projectors 1 can be reflected to an entire area around the mirror ball 2, as viewed from a ceiling 350 (Z1 side), unlike the case where only one projector 1 is arranged. Consequently, an undistorted or unseparated (unbroken) image can be easily projected on the entire area around the mirror ball 2.

The remaining effects of the second embodiment are similar to those of the aforementioned first embodiment.

### Third Embodiment

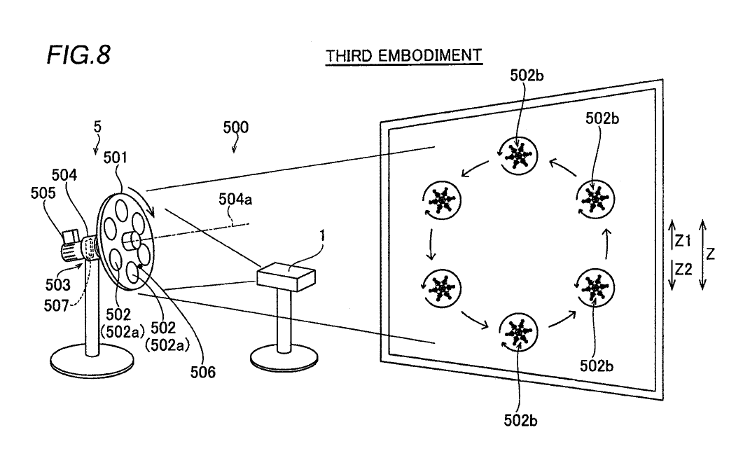

The structure of a projector system 500 according to a third embodiment of the present invention is now described with reference to FIG. 8.

In this third embodiment, the projector system 500 configured to emit light forming an image to a light reflector 5 having a mirror fixing member 501 in the form of a flat plate from a projector 1 is described unlike the first embodiment showing an example of projecting the light forming the image on the substantially spherical mirror ball 2 from the projector 1.

As shown in FIG. 8, the projector system 500 according to the third embodiment includes the projector 1 and the light reflector 5. In this projector system 500, light constituting an image projected from the projector 1 is reflected by a plurality of mirror portions 502, described later, of the light reflector 5, whereby the image is swept in space (on a wall surface or the like to which the light reflected by the mirror portions 502 is emitted). The projector 1 and the light reflector 5 are arranged at a previously determined interval. Furthermore, the projector 1 and the light reflector 5 are arranged such that a projection optical axis of the projector 1 and the mirror portions 502 of the light reflector 5 have an angle previously determined according to the projection position of the image. The projector 1 is fixed to a stand and is configured to be portable. In other words, the projector 1 is a portable mobile projector

The light reflector 5 includes the mirror fixing member 501, the mirror portions 502, a supporting portion 503, a stepping motor 504, an encoder 505, a light detecting portion 506, and a communication portion 507. The light reflector 5 is configured to be portable. In other words, the light reflector 5 is a portable mobile light reflector. The stepping motor 504 is an example of the “drive portion” in the present invention. The encoder 505 is an example of the “position detecting portion” in the present invention.

The mirror fixing member 501 is made of a substantially circular flat plate (is substantially circularly formed). The plurality of mirror portions 502 are arranged on a surface of the mirror fixing member 501.

The plurality of mirror portions 502 are arranged at substantially the same intervals from the center (a rotation axis 504a described later) of the mirror fixing member 501. Furthermore, the plurality of mirror portions 502 are arranged such that adjacent mirror portions 502 are equally spaced. Reflecting surfaces 502a of the mirror portions 502 are formed such that the vicinities of central portions thereof are recessed with respect to the vicinities of edges thereof (each have a concave cross-sectional shape). The projector 1 is set such that the side thereof closer to the mirror portions 502 of the mirror fixing member 501 is in an upward direction. The plurality of mirror portions 502 are arranged such that the reflecting surfaces 502a are substantially parallel to each other.

The stepping motor 504 has the rotation axis 504a. The plurality of mirror portions 502 set on the mirror fixing member 501 are configured to be rotated (moved) about the rotation axis 504a.

The single light detecting portion 506 is arranged between the adjacent mirror portions 502. Light intensity detected by the light detecting portion 506 is maximized at a position where the light detecting portion 506 is the closest to the projector 1 (a position where the mirror fixing member 501 is rotated so that the light detecting portion 506 is arranged on the lowest side).

According to the third embodiment, image data (table 121 (see FIG. 3)) is configured such that each of a plurality of images 502b rotates while the images projected from the projector 1 are synchronized with (follow) revolution of the mirror portions 502 about the rotation axis 504a. Furthermore, the image data is configured such that the colors of the images projected from the projector 1 change according to the positions of the mirror portions 502. An image processing portion 111 is configured to be capable of switching the images 502b to allow the plurality of images 502b projected on the plurality of mirror portions 502 to revolve about the center of the plurality of mirror portions 502 as a revolution center in synchronization with the movement of the plurality of mirror portions 502 on the basis of positional information of the plurality of mirror portions 502. Furthermore, the image processing portion 111 is configured to be capable of switching the images 502b to allow the plurality of images 502b projected on the plurality of mirror portions 502 to independently rotate about the centers of the plurality of mirror portions 502 as rotation centers. Thus, the image processing portion 111 can perform control of projecting the images in synchronization with (following) the movement (revolution) of the mirror portions 502, rotating the images, and changing the colors of the images.

The remaining structure of the projector system 500 according to the third embodiment is similar to that of the projector system 300 according to the aforementioned first embodiment.

According to the aforementioned third embodiment, the following effects can be obtained.

According to the third embodiment, as hereinabove described, the projector system 500 is provided with the image processing portion 111 of the projector 1 acquiring the positional information of the moving mirror portions 502 from the light reflector 5 and switching the image projected by the projector 1 on the basis of the positional information of the moving mirror portions 502. Thus, the image can be reliably projected on the mirror portions 502 on the basis of the positional information of the moving mirror portions 502 even if the positions of the mirror portions 502 are changed, and hence separation (breaks) of the images 502b reflected by the mirror portions 502 on a projection surface such as a wall surface can be suppressed. Consequently, a reduction in the quality of the images projected by the moving mirror portions 502 can be suppressed.

According to the third embodiment, as hereinabove described, the projector system 500 is constituted by the portable light reflector 5 and the portable projector 1. Thus, a user can easily arrange the projector system 500 at a desired place, and hence user convenience can be improved.

According to the third embodiment, as hereinabove described, the plurality of mirror portions 502 are arranged such that the reflecting surfaces 502a are substantially parallel to each other. Thus, the images 502b can be easily rotated while the separation of the images 502b reflected by the mirror portions 502 on the projection surface is suppressed.

According to the third embodiment, as hereinabove described, the image processing portion 111 of the projector 1 is configured to be capable of switching the images 502b to allow the plurality of images 502b projected on the plurality of mirror portions 502 to revolve about the center of the plurality of mirror portions 502 as the revolution center in synchronization with the movement of the plurality of mirror portions 502 on the basis of the positional information of the plurality of mirror portions 502 and switching the images 502b to allow the plurality of images 502b projected on the plurality of mirror portions 502 to independently rotate about the centers of the plurality of mirror portions 502 as the rotation centers on the basis of the positional information of the plurality of mirror portions 502. Thus, the plurality of mirror portions 502 can rotate while the images 502b are projected (revolved) in synchronization with the movement of the plurality of mirror portions 502. Consequently, patterns of the movement of the projected images 502b can be increased while the separation of the images 502b reflected by the mirror portions 502 on the projection surface such as the wall surface is suppressed.

The remaining effects of the third embodiment are similar to those of the aforementioned first embodiment.

The embodiments disclosed this time must be considered as illustrative in all points and not restrictive. The range of the present invention is shown not by the above description of the embodiments but by the scope of claims for patent, and all modifications within the meaning and range equivalent to the scope of claims for patent are further included.

For example, while the present invention is applied to the projector system including the scanning projector(s) having the MEMS mirror in each of the aforementioned first to third embodiments, the present invention is not restricted to this. The present invention may alternatively be applied to a projector system including a projector(s) other than the scanning projector(s).

While the single projector is provided in the aforementioned first embodiment and the two projectors are provided in the aforementioned second embodiment, the present invention is not restricted to this. According to the present invention, three or more projectors may alternatively be provided.

While the mirror portions are rotated at one degree angular intervals about the rotation axis in each of the aforementioned first to third embodiments, the present invention is not restricted to this. According to the present invention, the mirror portions may alternatively be rotated about the rotation axis at angular intervals other than the one degree angular intervals.

While the mirror portions are rotated (moved) about the rotation axis in each of the aforementioned first to third embodiments, the present invention is not restricted to this. According to the present invention, the mirror portions may alternatively be configured to reciprocate in a linear or arcuate trajectory.

While the table for projecting the image includes the image data corresponding to the positions of the mirror portions and the inclination of the mirror portions at those positions in each of the aforementioned first to third embodiments, the present invention is not restricted to this. According to the present invention, the table for projecting the image may alternatively include image data corresponding to only the positions of the mirror portions.

While the incremental encoder is provided in each of the aforementioned first to third embodiments, the present invention is not restricted to this. According to the present invention, an absolute position detecting portion capable of detecting an absolute position may alternatively be provided. In this case, the reference position (position in the initial state) of the mirror portions (mirror fixing member) may not be set, and hence the light detecting portion 206 may not be provided, so that the number of components can be reduced.

While the control of setting the mirror ball (light reflector) at the reference position is performed before the projection of the image in each of the aforementioned first to third embodiments, the present invention is not restricted to this. According to the present invention, the control of setting the light reflector at the reference position may alternatively be performed not only before the projection of the image but also during the projection of the image.

While the image is projected in synchronization with the rotation (movement) of the mirror ball (light reflector) on the basis of the table previously stored in the storage portion in each of the aforementioned first to third embodiments, the present invention is not restricted to this. According to the present invention, the control portion may alternatively process externally input image data in real time to project an image in synchronization with the rotation (movement) of the light reflector.

While the images are projected in synchronization with (following) the movement (revolution) of the mirror portions, each of the images rotates, and the colors of the images are changed in the aforementioned third embodiment, the present invention is not restricted to this. According to the present invention, either the control of changing the colors of the images or the control of rotating each of the images may alternatively be performed while the images are projected in synchronization with the movement of the mirror portions. Furthermore, control of changing the sizes of the images or the shapes of the images may alternatively be performed while the images are projected in synchronization with the movement of the mirror portions.

While the projector(s) and the mirror ball (light reflector) transmit/receive the information (data) to/from each other wirelessly in each of the aforementioned first and second embodiments and the projector and the light reflector transmit/receive the information to/from each other wirelessly in the aforementioned third embodiment, the present invention is not restricted to this. According to the present invention, the projector and the light reflector may alternatively transmit/receive information to/from each other through a wire.

While the processing operations performed by the control portion are described, using the flowchart described in a flow-driven manner in which processing is performed in order along a processing flow for the convenience of illustration in each of the aforementioned first to third embodiments, the processing operations performed by the control portion may alternatively be performed in an event-driven manner in which processing is performed on an event basis, for example. In this case, the processing operations performed by the control portion may be performed in a complete event-driven manner or in a combination of an event-driven manner and a flow-driven manner.

What is claimed is:

1. A projector system comprising:
a projector including a light projection portion projecting an image and a control portion; and
a light reflector including a mirror portion reflecting light constituting the image projected by the projector to a prescribed region, a drive portion moving the mirror portion, and a position detecting portion capable of detecting a position of the mirror portion, wherein
the control portion of the projector is configured to acquire positional information of the mirror portion from the light reflector and switch the image projected by the projector on the basis of the positional information of the mirror portion.

2. The projector system according to claim 1, wherein
the control portion of the projector is configured to switch the image projected by the projector in synchronization with movement of the mirror portion on the basis of the positional information of the mirror portion.

3. The projector system according to claim 2, wherein
the control portion of the projector is configured to calculate a movement speed of the mirror portion from the positional information of the mirror portion and switch the image projected by the projector in synchronization with the movement of the mirror portion on the basis of the movement speeds that is calculated.

4. The projector system according to claim 1, wherein
the light projection portion includes a light scanning portion projecting the image by scanning the light, and
the control portion of the projector is configured to acquire the positional information of the mirror portion from the light reflector and switch the image scanned by the light scanning portion such that the light is emitted only to the mirror portion on the basis of the positional information of the mirror portion.

5. The projector system according to claim 1, wherein
the control portion of the projector is configured such that the image projected by the light projection portion follows movement of the mirror portion on the basis of the positional information of the mirror portion acquired from the light reflector.

6. The projector system according to claim 1, wherein
the position detecting portion includes an encoder,
the light reflector includes a mirror fixing member on which a plurality of mirror portions rotatable about a rotation axis are set,
the drive portion of the light reflector is configured to rotate the mirror fixing member about the rotation axis, and
the control portion of the projector is configured to be capable of acquiring information about a rotation angle of the mirror fixing member detected by the encoder of the light reflector and switch the image projected by the projector on the basis of the information about the rotation angle of the mirror fixing member.

7. The projector system according to claim 6, wherein
the drive portion is configured to be capable of changing rotation speeds of the mirror portions, and
the control portion of the projector is configured to switch the image projected by the projector in synchronization with rotation of the mirror portions on the basis of information about the rotation speeds of the mirror portions that are changed when the rotation speeds of the mirror portions are changed.

8. The projector system according to claim 1, wherein
the projector includes a storage portion storing a table in which a movement position of the mirror portion and an image corresponding to the movement position of the mirror portion are associated with each other, and
the control portion of the projector is configured to switch the image projected by the projector on the basis of information about a rotation speed of the mirror portion and information in the table.

9. The projector system according to claim 8, wherein
the table is configured to associate the image corresponding to not only the movement position of the mirror portion but also an inclination angle of the mirror portion at the movement position of the mirror portion with the movement position of the mirror portion.

10. The projector system according to claim 9, wherein
the table is configured to associate the image distorted according to the inclination angle of the mirror portion with the movement position of the mirror portion.

11. The projector system according to claim 8, wherein
the drive portion is configured to rotate the mirror portion by a prescribed rotation pitch angle, and
the table is configured to include images corresponding in number to a number obtained by dividing 360 degrees by the prescribed rotation pitch angle.

12. The projector system according to claim 6, wherein
the plurality of mirror portions have substantially a same size, and
the control portion of the projector is configured to switch the image scanned by the light scanning portion such that the light is emitted to each of the mirror portions on the basis of the positional information of each of the mirror portions in substantially the same size.

13. The projector system according to claim 1, wherein
a light source of the projector comprises a laser beam source,
the mirror portion has a reflecting surface,
the reflecting surface is formed such that a vicinity of a central portion thereof is recessed with respect to a vicinity of an edge thereof, and
the mirror portion is configured to reflect a laser beam constituting the image projected by the projector to the prescribed region by the reflecting surface that is recessed.

14. The projector system according to claim 1, wherein
the light reflector includes a light detecting portion configured to set a reference position of the light reflector by detecting the light emitted from the projector.

15. The projector system according to claim 6, wherein
the control portion of the projector is configured to switch images to allow a plurality of images projected on the plurality of mirror portions to revolve about a center of the plurality of mirror portions as a revolution center in synchronization with movement of the plurality of mirror portions on the basis of the positional information of the plurality of mirror portions and switch the images to allow the plurality of images projected on the plurality of mirror portions to independently rotate about centers of the plurality of mirror portions as rotation centers on the basis of the positional information of the plurality of mirror portions.

16. The projector system according to claim 8, wherein
the projector and the light reflector are fixedly arranged at a prescribed interval therebetween, and
the control portion of the projector is configured to project the image on the light reflector while switching the image on the basis of the information in the table and the positional information of the mirror portion.

17. The projector system according to claim 1, wherein
a plurality of projectors are provided, and
the light reflector is arranged at a substantially central position between the plurality of projectors.

18. The projector system according to claim 1, wherein
the projector comprises a portable mobile projector,
the light reflector comprises a portable mobile light reflector,
the light reflector includes a plurality of mirror portions, and
the plurality of mirror portions are arranged such that reflecting surfaces thereof are substantially parallel to each other.

19. The projector system according to claim 6, wherein
the mirror fixing member has a substantially spherical shape or a substantially circular plate shape.

20. A projector comprising:
a light projection portion projecting an image; and
a control portion,
the control portion configured to acquire positional information of a movable mirror portion from a light reflector reflecting light constituting the image that is projected to a prescribed region, including the movable mirror portion and switch the image projected from the light projection portion on the basis of the positional information of the movable mirror portion.
